(19) United States
(12) Patent Application Publication
(10) Pub. No.: US 2026/0255445 A1
(43) Pub. Date: Aug. 27, 2026

(54) HEATER STRUCTURE

(71) Applicant: JAPAN AVIATION ELECTRONICS INDUSTRY, LIMITED, Tokyo (JP)

(72) Inventors: Shinpei NAKANO, Tokyo (JP); Akira IWASAKI, Tokyo (JP); Yusuke SUZUKI, Tokyo (JP); Keizo GOTO, Tokyo (JP); Kenji MATSUMOTO, Tokyo (JP)

(73) Assignee: JAPAN AVIATION ELECTRONICS INDUSTRY, LIMITED, Tokyo (JP)

(21) Appl. No.: 19/437,030

(22) Filed: Dec. 30, 2025

(30) Foreign Application Priority Data
Feb. 26, 2025 (JP) 2025-029093

(51) Int. Cl. H05B 3/00; H01B 5/14; H01R 11/01; H05B 3/18

(52) U.S. Cl. CPC H05B 3/0019; H01B 5/14; H01R 11/01; H05B 3/18; H05B 2203/01

(57) ABSTRACT

A heater portion of a heater structure is connected between main portions of two thick film busbars. The thick film busbars have first connecting portions, respectively. An anisotropic conductive film has two second connecting portions. Each of two thin film connecting portions connects the first connecting portion corresponding thereto to the second connecting portion corresponding thereto. The thick film busbars do not come into direct contact with the anisotropic conductive film. The thin film connecting portions are covered with an insulation coat 70 and the anisotropic conductive film so as not to be exposed except for connection portions with the thick film busbars.

### CROSS REFERENCE TO RELATED APPLICATIONS

This application is based on and claims priority under 35 U.S.C. §119 to Japanese Patent Application No. JP2025-029093 filed Feb. 26, 2025, the contents of which are incorporated herein in their entirety by reference.

### BACKGROUND OF THE INVENTION

This invention relates to a heater structure, in particular, to a planar heater structure.

As a connection method for connecting a flexible printed circuit (FPC) to a circuit board, a method using an anisotropic conductive film (ACF) is known. Such a method is disclosed in JP 2007-35546 A (Patent Document 1), for example.

The method disclosed in Patent Document 1 is carried out as shown in FIG. 13. First, a liquid crystal display panel 110, an anisotropic conductive film 120 and a flexible board 130 are put on a pressure bonding stage 100. At this time, the anisotropic conductive film 120 is placed between an electrode terminal 111 of the liquid crystal display panel 110 and an electrode terminal 131 of the flexible board 130. Next, the flexible board 130, the anisotropic conductive film 120 and the liquid crystal display panel 110 are pressed and heated by a heater bar 140 via a cushion member 150. As a result, the anisotropic conductive film 120 mechanically connects the liquid crystal display panel 110 with the flexible board 130 and electrically connects the electrode terminal 111 of the liquid crystal display panel 110 with the electrode terminal 131 of the flexible board 130.

### SUMMARY OF THE INVENTION

There is a request to connect a flexible printed circuit to a heater portion using an anisotropic conductive film in a planar heater structure. On the other hand, it is necessary to reduce electric resistance of components other than the heater portion in the planar heater structure in order to achieve high heat generation efficiency.

It is therefore an object of the present invention to provide a heater structure which can be connected to a flexible printed circuit by using an anisotropic conductive film and generate heat efficiently.

One aspect of the present invention provides a heater structure which comprises a heater portion, two thick film busbars, an anisotropic conductive film, two thin film connecting portions and an insulation coat and which has a planar shape. Each of the thick film busbars has a main portion and a first connecting portion. The main portions of the thick film busbars are located apart from each other. The heater portion spreads planarly and is connected between the main portions of the thick film busbars. The anisotropic conductive film has two second connecting portions. The thin film connecting portions correspond to the first connecting portions of the thick film busbars, respectively, and to the second connecting portions, respectively. Each of the thin film connecting portions connects the first connecting portion corresponding thereto to the second connecting portion corresponding thereto. The thick film busbars are not brought into direct contact with the anisotropic conductive film. Each of the thin film connecting portions is covered with the insulation coat and the anisotropic conductive film so as not to be exposed except for a connection portion with the thick film busbar.

In the heater structure of the above-mentioned aspect, the heater portion is connected between the main portions of the thick film busbars. Use of the thick film busbars allows the heater structure to generate heat efficiently. Moreover, in the heater structure of the above-mentioned aspect, each of the thin film connecting portions connects the first connecting portion of the thick film busbar corresponding thereto with the second connecting portion of the anisotropic conductive film corresponding thereto. Accordingly, without bringing the anisotropic conductive film into direct contact with the thick film busbars, the flexible printed circuit can be connected with the heater structure. As a result, the flexible printed circuit can be separated from the thick film busbars, and the thick film busbars can be easily and certainly prevented from corroding.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a transparent, plan view showing a heater structure according to an embodiment of the present invention.

FIG. 2 is an enlarged view showing a part enclosed by a dashed circle B in FIG. 1.

FIG. 3 is an enlarged view showing a part enclosed by a dashed circle C in FIG. 1.

FIG. 4 is an enlarged view showing a part enclosed by a dashed circle D in FIG. 1.

FIG. 5 is an enlarged view showing a part enclosed by a dashed circle E in FIG. 1.

FIG. 6 is a plan view explanatory of a first step of a manufacturing process for manufacturing the heater structure of FIG. 1. All elements are depicted as opaque elements.

FIG. 7 is a plan view explanatory of a second step of the manufacturing process for manufacturing the heater structure of FIG. 1. All elements are depicted as opaque elements.

FIG. 8 is a plan view explanatory of a third step of the manufacturing process for manufacturing the heater structure of FIG. 1. All elements are depicted as opaque elements.

FIG. 9 is a plan view explanatory of a fourth step of the manufacturing process for manufacturing the heater structure of FIG. 1. All elements are depicted as opaque elements.

FIG. 10 is a plan view explanatory of a fifth step of the manufacturing process for manufacturing the heater structure of FIG. 1. All elements are depicted as opaque elements. Electrodes of a flexible printed circuit are partly depicted by broken lines.

FIG. 11 is a plan view explanatory of a sixth step of the manufacturing process for manufacturing the heater structure of FIG. 1. All elements are depicted as opaque elements. The electrodes of the flexible printed circuit are partly depicted by broken lines.

FIG. 12 is a schematic view showing a structure of the heater structure and the flexible printed circuit of FIG. 11 on a cross-section taken along A-A line. A size and an aspect ratio of each element do not match with those of FIG. 11.

FIG. 13 is a diagram explaining a connecting method, which is for connecting a circuit board with a flexible printed circuit (FPC), of Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

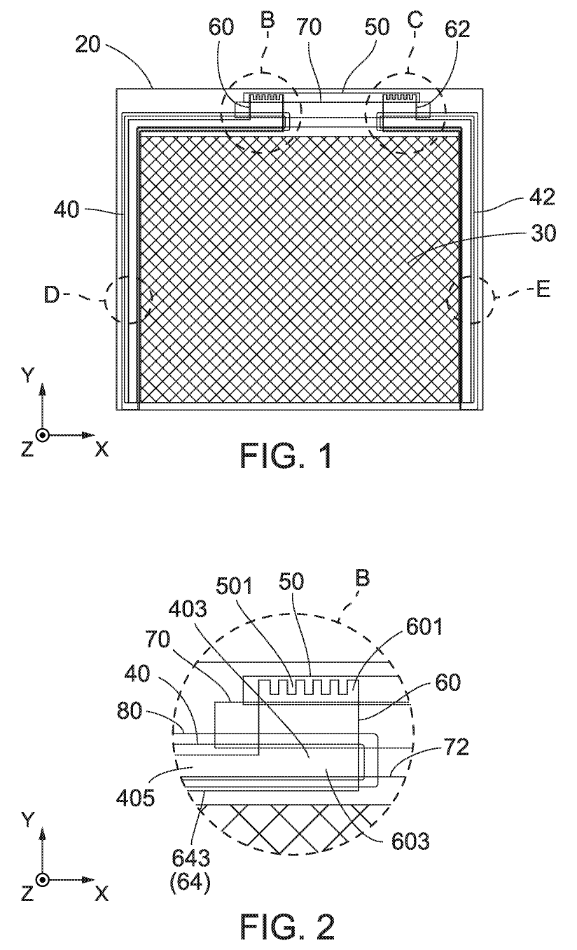

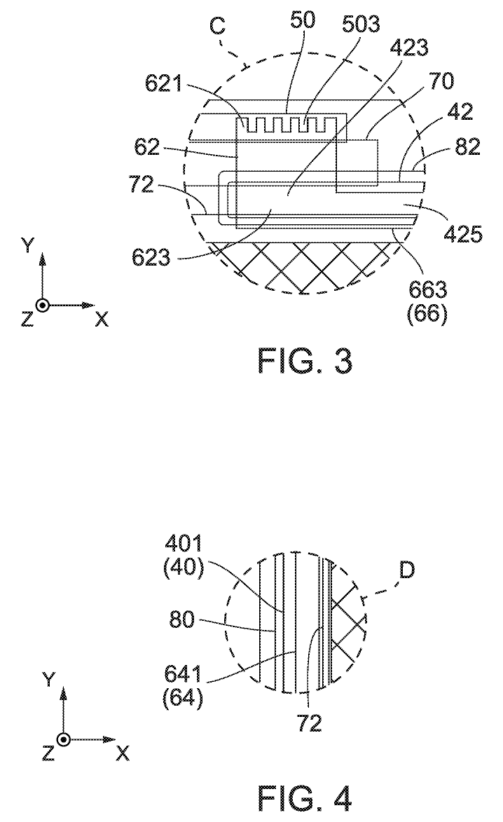

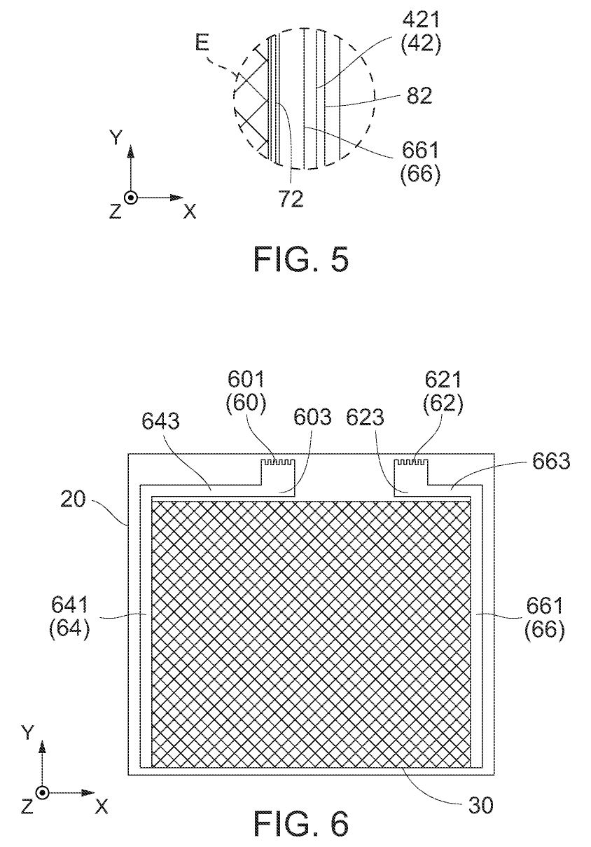

Referring to FIGS. 1 to 5, a heater structure 10 according to an embodiment of the present invention is a planar heater structure. The heater structure 10 is provided with a base member 20, a heater portion 30, two thick film busbars 40 and 42, an anisotropic conductive film 50, two thin film connecting portions 60 and 62 and an insulation coat 70. In the present embodiment, the heater structure 10 is further provided with two thin film busbars 64 and 66, an expanded insulation coat 72 and the sealing members 80 and 82.

As shown in FIGS. 1 to 5, the base member 20 has a rectangular shape when viewed from above. In the present embodiment, an up-down direction is a Z-direction. A positive Z-direction is directed upward while a negative Z-direction is directed downward. The base member 20 is a film made of insulation resin, such as polyethylene terephthalate (PET), polyethylene naphthalate (PEN), cyclo olefin polymer (COP) or polyimide. In the present embodiment, the base member 20 has flexibility. Moreover, in the present embodiment, the base member 20 is transparent. However, the present invention is not limited thereto. The base member 20 may have stiffness. Nevertheless, when the base member 20 has flexibility, the heater structure 10 can be used so as to be curved or to be put on a curved surface of a structural object. Moreover, the base member 20 may be opaque. Furthermore, the base member 20 may be made of glass. In addition, the base member 20 may have a shape other than the rectangular shape, such as a round shape or a trapezoid.

As shown in FIGS. 1 to 6, the heater portion 30 is formed on a surface of the base member 20 and spreads planarly. In the present embodiment, the heater portion 30 is a thin metal film with a mesh pattern. As a material for the metal thin film, a metal, such as Au, Ag, Al or Cu, may be used. However, the present invention is not limited thereto. The heater portion 30 may be a transparent conductive film, such as an indium tin oxide (ITO) film, provided that the heater portion 30 generates heat by the passage of electric current. In addition, the heater portion 30 may have a shape other than the mesh pattern, such as a striped pattern or a rectangle.

As understood from FIGS. 1 to 5 and 8, the thick film busbars 40 and 42 have main portions 401 and 421, respectively, and have first connecting portions 403 and 423, respectively. In the present embodiment, the thick film busbars 40 and 42 further have coupling portions 405 and 425, respectively. In each of the thick film busbars 40 and 42, the main portion 401 or 421, the coupling portion 405 or 425 and the first connecting portion 403 or 423 are integrally formed by using the same material. For example, the thick film busbars 40 and 42 may be formed by screen printing using a conductive paste including Au, Ag, Pd, Ni or Cu.

As shown in FIGS. 1 to 5 and 8, the thick film busbars 40 and 42 are spaced apart from each other in a first horizontal direction. The main portions 401 and 421 of the thick film busbars 40 and 42 extend in a second horizontal direction perpendicular to the first horizontal direction. The main portions 401 and 421 are spaced apart from each other in the first horizontal direction, and the heater portion 30 is placed between the main portions 401 and 421. In the present embodiment, the first horizontal direction is an X-direction, and the second horizontal direction is a Y-direction.

As shown in FIGS. 1 to 5 and 8, the first connecting portions 403 and 423 of the thick film busbars 40 and 42 extend in the first horizontal direction. The coupling portions 405 and 425 extend in the first horizontal direction and couple one ends of the main portions 401 and 421 to one ends of the first connecting portions 403 and 423, respectively.

As understood from FIGS. 1 to 5 and 9, the anisotropic conductive film 50 has a ribbon shape and extends in the first horizontal direction. The anisotropic conductive film 50 is a film in which conductive particles are dispersed in thermosetting resin. As the conductive particles, resin particles each of which is plated with a metal, such as Ni, Au or Pd, or metal particles each of which is made of a metal, such as Ni, Au or Pd, may be used. In the present embodiment, the anisotropic conductive film 50 has two second connecting portions 501 and 503. In the present embodiment, the second connecting portions 501 and 503 are located at both end portions of the anisotropic conductive film 50, respectively. However, the present invention is not limited thereto. The heater structure 10 of the present invention may have two anisotropic conductive films corresponding to the second connecting portions 501 and 503, respectively, instead of the anisotropic conductive film 50.

As shown in FIGS. 1 to 6, each of the thin film connecting portions 60 and 62 is formed by using a conductive thin film so as to have a generally rectangular shape. In the present embodiment, the thin film connecting portions 60 and 62 are formed by using the same material as that of the heater portion 30, or the thin metal film, at the same time that the heater portion 30 is formed.

As shown in FIGS. 1 to 6, the thin film connecting portions 60 and 62 are placed apart from each other in the first horizontal direction. The thin film connecting portions 60 and 62 correspond to the first connecting portions 403 and 423 of the thick film busbars 40 and 42, respectively, and correspond to the second connecting portions 501 and 503 of the anisotropic conductive film 50, respectively. In detail, the thin film connecting portions 60 and 62 have front-end portions 601 and 621 located at front ends thereof, respectively, and having a comb-tooth shape and have base portions 603 and 623 located at rear ends thereof, respectively. In the present embodiment, a front-rear direction is identical with the second horizontal direction. A positive Y-direction is directed forward while a negative Y-direction is directed rearward.

As understood from FIGS. 1 to 5, the front-end portions 601 and 621 of the thin film connecting portions 60 and 62 overlap with the second connecting portions 501 and 503 of the anisotropic conductive film 50, respectively, when viewed from above. The base portions 603 and 623 of the thin film connecting portions 60 and 62 overlap with the first connecting portions 403 and 423 of the thick film busbars 40 and 42, respectively, when viewed from above. In the present embodiment, the thin film connecting portions 60 and 62 protrude from the first connecting portions 403 and 423 of the thick film busbars 40 and 42 in the second horizontal direction, respectively, when viewed from above. In other words, in the present embodiment, the thin film connecting portions 60 and 62 protrude in a direction perpendicular to an extending direction of the first connecting portions 403 and 423. However, the present invention is not limited thereto. The thin film connecting portions 60 and 62 may protrude from the first connecting portions 403 and 423 of the thick film busbars 40 and 42 in the first horizontal direction, respectively, when viewed from above. In other words, the thin film connecting portions 60 and 62 may protrude in the extending direction of the first connecting portions 403 and 423. Nevertheless, when the thin film connecting portions 60 and 62 protrude in the direction perpendicular to the extending direction of the first connecting portions 403 and 423, contact areas with the second connecting portions 501 and 503 can be easily increased. Increase of the contact areas reduces electric resistance, so that heat generation efficiency of the heater structure 10 is increased.

As shown in FIGS. 1 to 6, the thin film connecting portions 60 and 62 are connected to the thin film busbars 64 and 66, respectively. In the present embodiment, the thin film busbars 64 and 66 are formed integrally with the heater portion 30 and the thin film connecting portions 60 and 62 by using the same material simultaneously.

As understood from FIGS. 1 to 6 and 8, the thin film busbars 64 and 66 are similar to the thick film busbars 40 and 42 in shape, respectively. In detail, as shown in FIGS. 1 to 6, the thin film busbars 64 and 66 have main portions 641 and 661, respectively, and have extension portions 643 and 663, respectively.

As shown in FIGS. 1 to 6, the main portions 641 and 661 of the thin film busbars 64 and 66 extend in the first horizontal direction and are connected to the heater portion 30. Moreover, the extension portions 643 and 663 of the thin film busbars 64 and 66 extend in the second horizontal direction. The main portions 641 and 661 of the thin film busbars 64 and 66 are located under the main portions 401 and 421 of the thick film busbars 40 and 42, respectively. Moreover, the extension portions 643 and 663 of the thin film busbars 64 and 66 are located under the coupling portions 405 and 425 of the thick film busbars 40 and 42, respectively. The main portions 641 and 661 of the thin film busbars 64 and 66 connect the main portions 401 and 421 of the thick film busbars 40 and 42 to the heater portion 30. Use of the thick film busbars 40 and 42 reduces electric resistance on a power supply line to the heater portion 30 and increases the heat generation efficiency of the heater structure 10.

As shown in FIGS. 1 to 5 and 7, the insulation coat 70 is located so as to cross the thin film connecting portions 60 and 62 in the first horizontal direction. The front-end portions 601 and 621 of the thin film connecting portions 60 and 62 are located forward of the insulation coat 70, while the base portions 603 and 623 of the thin film connecting portions 60 and 62 are located rearward of the insulation coat 70. In addition, the expanded insulation coat 72 is placed so as to cover the whole of the heater portion 30. The insulation coat 70 and the expanded insulation coat 72 are also called an overcoat and made of resin, such as thermosetting resin or photocurable resin.

As understood from FIGS. 1 to 5, 10 and 11, the sealing members 80 and 82 are formed so as to cover the thick film busbars 40 and 42, respectively. The sealing members 80 and 82 are made of resin, such as thermosetting resin or photocurable resin. The sealing members 80 and 82 may be made of a material same as or different from those of the insulation coat 70 and the expanded insulation coat 72.

Hereinafter, referring to FIGS. 6 to 12, the description will be made about a method for manufacturing the heater structure 10 and further made about the structure of the heater structure 10.

First, as shown in FIG. 6, the heater portion 30, the thin film connecting portions 60 and 62 and the thin film busbars 64 and 66 are formed on the surface of the base member 20. The heater portion 30, the thin film connecting portions 60 and 62 and the thin film busbars 64 and 66 can be simultaneously formed by patterning a thin metal film formed on the base member 20. In the present invention, the thin film busbars 64 and 66 are not essential. However, the thin film busbars 64 and 66 make formation of the thick film busbars 40 and 42 easy and are useful to improve reliability of electrical connection between each of the thick film busbars 40 and 42 and the heater portion 30.

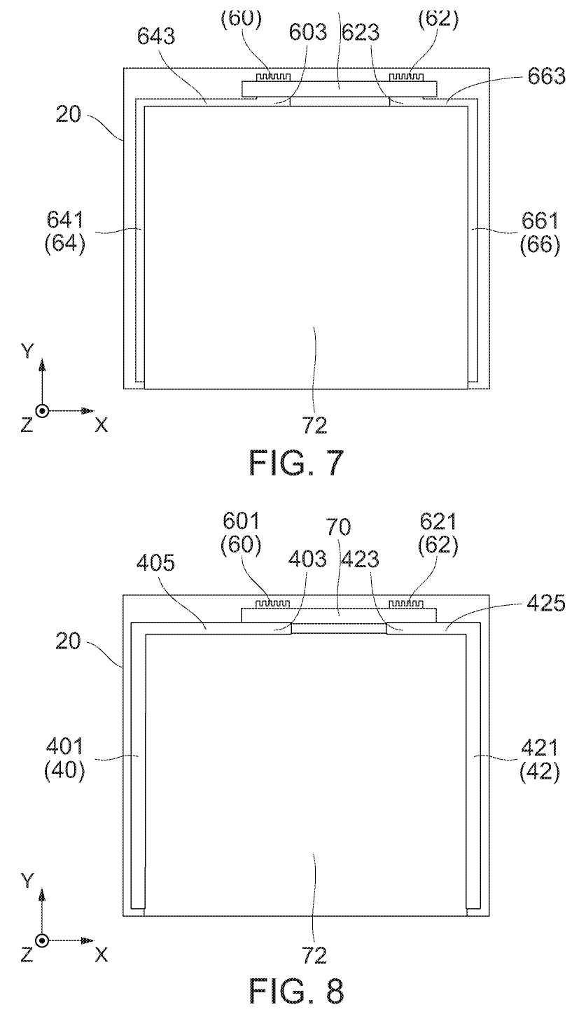

Next, as shown in FIG. 7, the insulation coat 70 and the expanded insulation coat 72 are formed. The insulation coat 70 and the expanded insulation coat 72 can be simultaneously formed by forming an insulating film and patterning the insulating film. The insulation coat 70 may be divided into two so that they correspond to the thin film connecting portions 60 and 62, respectively.

Next, as shown in FIG. 8, the thick film busbars 40 and 42 are formed. The thick film busbars 40 and 42 can be simultaneously formed by a method, such as screen printing using conductive paste. The thick film busbars 40 and 42 are formed so as to overlap with the thin film busbars 64 and 66 and with the base portions 603 and 623 of the thin film connecting portions 60 and 62. As a result, the first connecting portions 403 and 423 of the thick film busbars 40 and 42 are electrically connected to the thin film connecting portions 60 and 62, respectively. Moreover, the thick film busbars 40 and 42 are connected to the heater portion 30 via the thin film busbars 64 and 66. However, the present invention is not limited thereto. The thick film busbars 40 and 42 may be directly connected to the heater portion 30. At any rate, the heater portion 30 is connected between the main portions 401 and 421 of the thick film busbars 40 and 42.

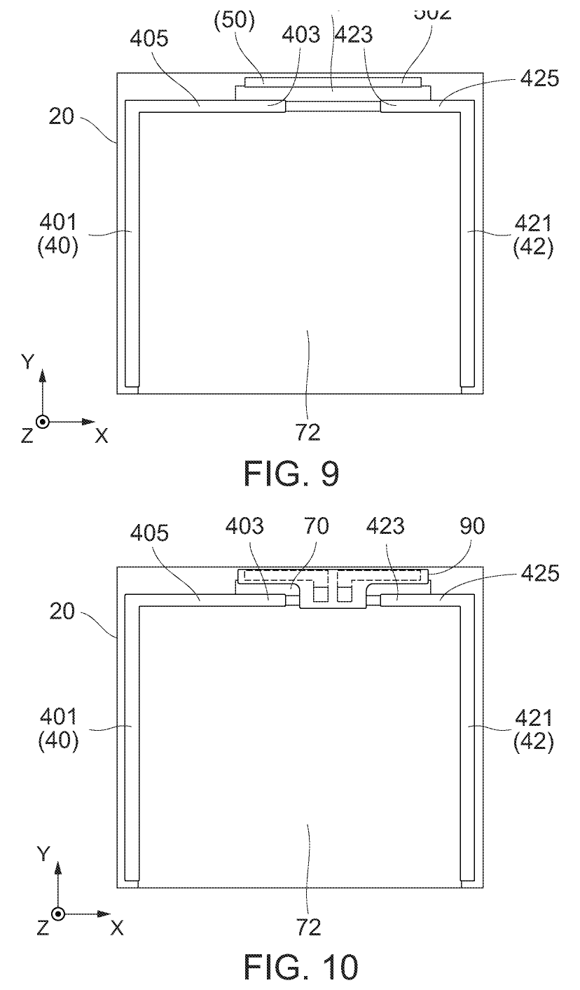

Next, as shown in FIG. 9, the anisotropic conductive film 50 is attached so as to cover the front-end portions 601 and 621 of the thin film connecting portions 60 and 62. The anisotropic conductive film 50 is attached so as to overlap with the insulation coat 70. As mentioned above, the anisotropic conductive films corresponding to the thin film connecting portions 60 and 62, respectively, may be used instead of the anisotropic conductive film 50. Nevertheless, the use of a single film, or the anisotropic conductive film 50, is preferable in order to avoid an increase in the number of components and an increase in the number of process steps.

Next, as shown in FIG. 10, a flexible printed circuit (FPC) 90 is connected and fixed to the heater structure 10 using the anisotropic conductive film 50. In detail, the flexible printed circuit (FPC) 90 is put on the anisotropic conductive film 50, and the flexible printed circuit (FPC) 90 is pressed toward the base member 20 and heated.

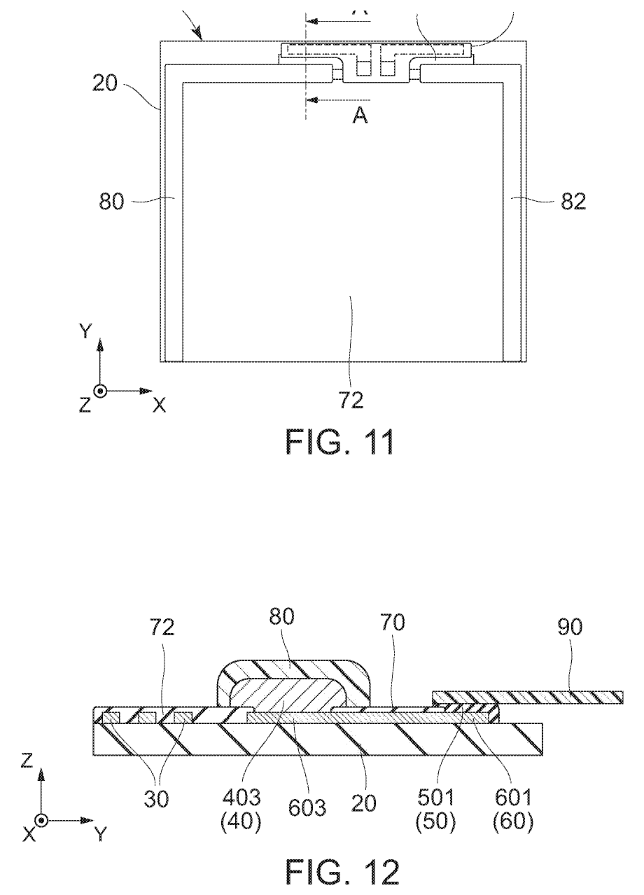

Lastly, as shown in FIG. 11, the sealing members 80 and 82 are formed so as to cover the thick film busbars 40 and 42, respectively. The sealing members 80 and 82 cover the thick film busbars 40 and 42, respectively, so that the thick film busbars 40 and 42 are not exposed. The sealing members 80 and 82 serve as moisture-proof or waterproof materials and prevent the thick film busbars 40 and 42 from being corroded. In this way, the heater structure 10 connected to the flexible printed circuit (FPC) 90 is achieved.

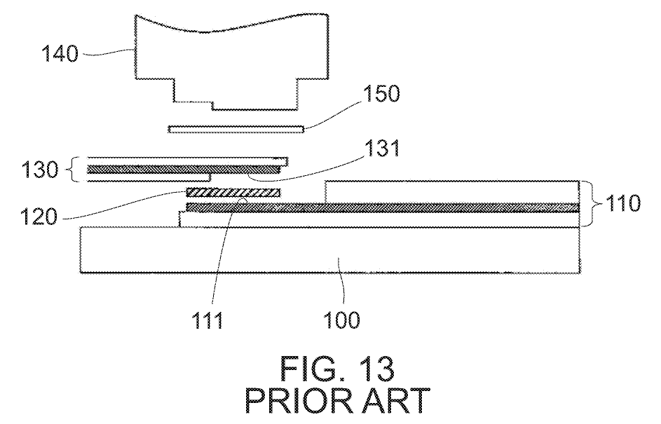

As understood from FIG. 12, in the achieved heater structure 10, the thin film connecting portion 60 connects the first connecting portion 403 of the thick film busbar 40 to the second connecting portion 501 of the anisotropic conductive film 50. Similarly, the thin film connecting portion 62 connects the first connecting portion 423 of the thick film busbar 42 to the second connecting portion 503 of the anisotropic conductive film 50. As just described, each of the thin film connecting portions 60 and 62 connects the first connecting portions 403 or 423 corresponding thereto to the second connecting portions 501 or 503 corresponding thereto.

As understood from FIG. 12, due to the use of the thin film connecting portions 60 and 62, the thick film busbars 40 and 42 are spaced apart from the anisotropic conductive film 50 and are not brought into direct contact with the anisotropic conductive film 50. Accordingly, the flexible printed circuit (FPC) 90 connected to the heater structure 10 does not overlap with the thick film busbars 40 and 42 when viewed from above. With this structure, the flexible printed circuit (FPC) 90 does not prevent formation of the sealing members 80 and 82 when the sealing members 80 and 82 are formed. Thus, the sealing members 80 and 82 can completely cover the thick film busbars 40 and 42, respectively, and prevent the thick film busbars 40 and 42 from being corroded. Furthermore, the thin film connecting portions 60 and 62 are covered by the insulation coat 70 and the anisotropic conductive film 50, except for connection portions with the thick film busbars 40 and 42, so as to not be exposed. In particular, the anisotropic conductive film 50 covers, by using a thickness thereof, edge portions of the thin film connecting portions 60 and 62 at connection portions between the thin film connecting portions 60 and 62 and the flexible printed circuit (FPC) 90 and completely seals the connection portions. Accordingly, the thin film connecting portions 60 and 62 are also prevented from being corroded. The thick film busbars 40 and 42 and the thin film connecting portions 60 and 62 are prevented from being corroded, so that an increase in the electric resistance caused by corrosion can be prevented, and the high heat generation efficiency of the heater structure 10 can be maintained.

Although the specific explanation about the present invention is made above with reference to concrete embodiments, the present invention is not limited thereto but susceptible of various modifications and alternative forms without departing from the spirit of the invention. For example, in the aforementioned embodiment, the thick film busbars 40 and 42 have the coupling portions 405 and 425, respectively, and each of the thick film busbars 40 and 42 has an L-shape. However, the present invention is not limited thereto. The thick film busbars 40 and 42 may not have the coupling portions 405 and 425, but each of the thick film busbars 40 and 42 may have an I-shape. In that case, the thin film connecting portions 60 and 62 may protrude, in either the first horizontal direction or the second horizontal direction, from the first connecting portions 403 and 423 of the thick film busbars 40 and 42 extending in the second horizontal direction. Nevertheless, the contact areas with the second connecting portions 501 and 503 can be easily increased when the thin film connecting portions 60 and 62 protrude in a direction perpendicular to the extending direction of the first connecting portions 403 and 423. Accordingly, in this case, the contact areas with the second connecting portions 501 and 503 can be easily increased when the thin film connecting portions 60 and 62 protrude in the second horizontal direction. Increase of the contact areas reduces the electric resistance, so that the heat generation efficiency of the heater structure 10 is increased.

Moreover, in the aforementioned embodiment, the thick film busbars 40 and 42 are formed so as to overlap with the insulation coat 70 and the expanded insulation coat 72. However, the thick film busbars 40 and 42 may not overlap with either the insulation coat 70 or the expanded insulation coat 72, or both the insulation coat 70 and the expanded insulation coat 72. Nevertheless, the sealing members 80 and 82 should be formed so as to overlap with the insulation coat 70 and the expanded insulation coat 72.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A heater structure comprising a heater portion, two thick film busbars, an anisotropic conductive film, two thin film connecting portions and an insulation coat and having a planar shape, wherein:
each of the thick film busbars has a main portion and a first connecting portion;
the main portions of the thick film busbars are located apart from each other;
the heater portion spreads planarly and is connected between the main portions of the thick film busbars;
the anisotropic conductive film has two second connecting portions;
the thin film connecting portions correspond to the first connecting portions of the thick film busbars, respectively, and to the second connecting portions, respectively;
each of the thin film connecting portions connects the first connecting portion corresponding thereto to the second connecting portion corresponding thereto;
the thick film busbars are not brought into direct contact with the anisotropic conductive film; and
each of the thin film connecting portions is covered with the insulation coat and the anisotropic conductive film so as not to be exposed except for a connection portion with the thick film busbar.

2. The heater structure as recited in claim 1, wherein the heater structure further comprises a sealing member which covers the thick film busbars so that the thick film busbars are not exposed.

3. The heater structure as recited in claim 1, wherein:
each of the first connecting portions of the thick film busbars extends in a first horizontal direction; and
when viewed from above, each of the thin film connecting portions protrudes from the first connecting portion corresponding thereto in a second horizontal direction perpendicular to the first horizontal direction.

4. The heater structure as recited in claim 1, wherein:
the heater structure further comprises two thin film busbars;
the thin film busbars are located under the thick film busbars, respectively, and connect the thick film busbars to the heater portion; and
the thin film connecting portions are formed integrally with the thin film busbars, respectively.
